(19) United States
(12) Patent Application Publication
(10) Pub. No.: US 2014/0351037 A1
(43) Pub. Date: Nov. 27, 2014

(54) TRAVEL PLANNING

(71) Applicant: GOEURO CORP., Astoria, NY (US)

(72) Inventors: Naren Shaam, Astoria, NY (US); Patrick Schweizer, Berlin (DE); Benjamin Emde, Waldeck (DE)

(73) Assignee: GOEURO CORP., Astoria, NY (US)

(21) Appl. No.: 14/284,876

(22) Filed: May 22, 2014

Related U.S. Application Data
(60) Provisional application No. 61/827,307, filed on May 24, 2013.

(51) Int. Cl. G06Q 50/14; G06Q 30/02

(52) U.S. Cl. CPC G06Q 50/14; G06Q 30/0222
USPC 705/14.23

(57) ABSTRACT

Among other things, information is received from a user interacting with a user interface about a trip that is being planned from an origin to a destination, the information including a user indication of travel modes to be considered in planning the trip and the possible travel modes including at least three of bus, train, car, water, and air. Two or more alternative travel options are determined each including two or more of the modes based on the received information; and the options are presented to the user through the user interface.

### RELATED APPLICATIONS

This application is entitled to the benefit of U.S. provisional application 61/827,307, filed May 24, 2013, which is incorporated here by reference in its entirety.

### BACKGROUND

This description relates to travel planning

### SUMMARY

In general, in an aspect, information is received from a user interacting with a user interface about a trip that is being planned from an origin to a destination, the information including a user indication of travel modes to be considered in planning the trip and the possible travel modes including at least three of bus, train, car, water, and air. Two or more alternative travel options are determined each including two or more of the modes based on the received information; and presenting the options to the user through the user interface.

Implementations may include one or more of the following features. All of the modes of travel are displayed in the user interface in one portal. Travel mode preferences of the user are stored. Origins and destinations are stored for a user for later use. Previous origins and destinations of a user are displayed. A graphic display of a current origin and destination of a trip is presented. A city, town, or village or in some cases any user provided address is used as an origin and destination. Alternative options are presented on a single screen.

In general, in an aspect, a presentation is made to a user through a user-interface of a comparison of respective travel times for a trip being planned from an origin to a destination. The respective travel times are for alternative travel options that include travel modes. The travel modes including at least two of bus, train, air, water (for example, a ferry), and car.

Implementations may include one or more of the following features. If the journey is long or short, only one mode of travel may be presented. When the journey is long, the one mode may be air. When the journey is short, the one mode may be train or bus. Cached geolocation information is geocentrically mapped (or mapped in other ways) to determine closest (that is, the relevant) airports to the origin and the destination. Determining relevant airports includes excluding airports that are inaccessible or for which an overlap exists. If insufficient geolocation information has been cached, a live mapping service is used. The live mapping service maps the geo coordinates of the location to the geo coordinates of the closest airports, train stations or bus stops using distance-based mapping to determine the relevant airports, train stations or bus stops and to identify routing and pricing. Cached or live information is used to determine train or bus connections to or from airports or to determine routes using train only or bus only options. If no trains are identified for connections from city centres to the airports, a distance estimate is used to determine how long it takes to get to the airport as part of determining a total travel time. Total travel time is estimated using mixed travel modes. If no trains are identified for connections from city centres to airports, a distance estimate is used to determine how long it takes to get to the airport as part of determining a total travel time.

In general, in an aspect, a determination is made for a user of a travel option for a trip being planned between an origin and a destination. The travel option includes at least two modes of travel. At least one of the modes of travel includes bus, train, car, plane, or water. The user can book at least one segment of the travel sequence without booking another segment of the travel sequence.

Implementations may include one or more of the following features. At least one of the origin and the destination is not an airport. At least one of the origin and the destination is a city center or in some cases any address at all.

In general, in an aspect, a favorable price is determined for a travel option for a trip from an origin to a destination. The travel option includes travel segments that can include at least two of bus, train, car, water, and air. Determining of the favorable price includes comparing alternative possible travel sequences. If the travel option includes an air segment, the travel options to be compared are selected based on nearest relevant airports to the origin and the destination and train segments from the origin to the nearest airports and train segments to the ending point from the nearest airports. If the travel option includes only bus segments or only train segments, available schedules and prices are compared.

Implementations may include one or more of the following features. Car rental options are calculated and displayed for each mode based on price and time. Local inner-city transportation travel modes are considered.

In general, in an aspect, information is received from a user interacting with a user interface about a trip that is being planned from an origin to a destination. The information includes a user indication of travel modes to be considered in planning the trip. The possible travel modes include at least two of bus, train, car, water, and air. Two or more alternative travel options are determined, each including two or more of the modes based on the received information. Filter options are displayed through the user interface that enable the user to filter the travel options based on any one or more of any of the travel modes. The options are presented to the user through the user interface.

Implementations may include one or more of the following features. Options are also determined that include train only or bus only travel modes for the trip and the travel only and bus only travel modes are priced in comparison to options that include two or more travel modes.

In general, in an aspect, options for modes of travel are displayed to a user of a travel planning facility. The modes include air only, train only, bus only, and multi-mode options for travel from an origin to a destination. Information is also displayed that enables the user to compare two or more of the options based on total travel time or total travel price or both between the origin and the destination.

In general, in an aspect, options are displayed to a user of a travel planning facility that enable the user to select among modes of travel from an origin to a destination and to view options for a mode that the user has selected to view. For the selected mode, options are displayed that include that mode and also include one or more connections that use one or more other modes.

Implementations may include one or more of the following features. The selected mode includes air and the connections comprise at least one of car, public transportation, train, or bus to airports associated with the air options.

In general, in an aspect, travel planning information is displayed to a user that includes information about lodging options at a destination. The user can select among groups of lodging options for display that represent different modes of lodging. Options only for the selected mode are then displayed, and not options for other modes.

Implementations may include one or more of the following features. The modes include at least a hotel mode and a hostel mode.

In general, in an aspect, a computer calculates the cost of a travel itinerary of a user from an origination location to a destination location. The calculation takes account of a discount or promotion that is available to the user to be applied against the cost of at least one part of the travel itinerary. The calculated cost of the itinerary is provided to the user through an online user interface.

Implementations may include one or a combination of two or more of the following features. The travel itinerary includes two or more parts. Taking account of the discount or promotion includes using information about the discount or promotion that is maintained as part of a stored profile of the user. Taking account of the discount or promotion includes using information about the discount or promotion that is provided by the user through the user interface. Calculating the cost of the travel itinerary includes calculating the costs of alternative possible itineraries and taking account of the discounts or promotions available for the respective alternative itineraries. The discount or promotion includes a bonus card. The user is asked to enter information about the discount or promotion by presenting to the user a selection list of available discounts and promotions to the user. The presented selection list does not include discounts or promotions that are not relevant to the itinerary for which the cost is being calculated.

In general, in an aspect, a graphical representation of alternative possible travel is displayed to a user in an online user interface. At least two of the alternative possible travel itineraries include different modes of travel.

Implementations may include one or a combination of two or more of the following features. The graphical representation is arranged to show the cost and the duration of each of the possible travel itineraries. At least one of the possible travel itineraries includes two different modes of travel. The graphical representation is adjusted when a user invokes a control to choose the cheapest itinerary or the shortest itinerary. The graphical representation associated with each of the itineraries can be invoked by a user to cause full details of the itinerary to be displayed. The graphical representation includes bars. The full details of the different itineraries are presented in respective tabs of a tabbed panel. The each of the tabs is associated with a corresponding mode of travel. The mode of travel associated with a tab is the mode of travel of a main leg of the corresponding itinerary. The full details for an air tab include not only the air time but also waiting time and time for transit to or from an airport. The transit time includes optionally time for public transportation when the airport is served by public transportation and optionally time for train or bus to the airport if one is available.

In general, in an aspect, a computer calculates a cost of a travel itinerary of a user from an origination location to a destination location. The travel itinerary has a portion that is priceable and a portion that is not priceable, the cost being calculated by pricing as much of the itinerary as possible.

Implementations may include one or a combination of two or more of the following features. The calculating includes determining a station that is nearest to the destination location and finding priceable travel mode to the determined station.

These and other aspects, features, and implementations, and combinations of them, can be expressed as methods, apparatus, program products, business methods, means and steps for performing functions, systems, components, databases, and user interfaces, and in other ways.

Other advantages, aspects, features, and implementations will become apparent from the following description and from the claims.

### DESCRIPTION

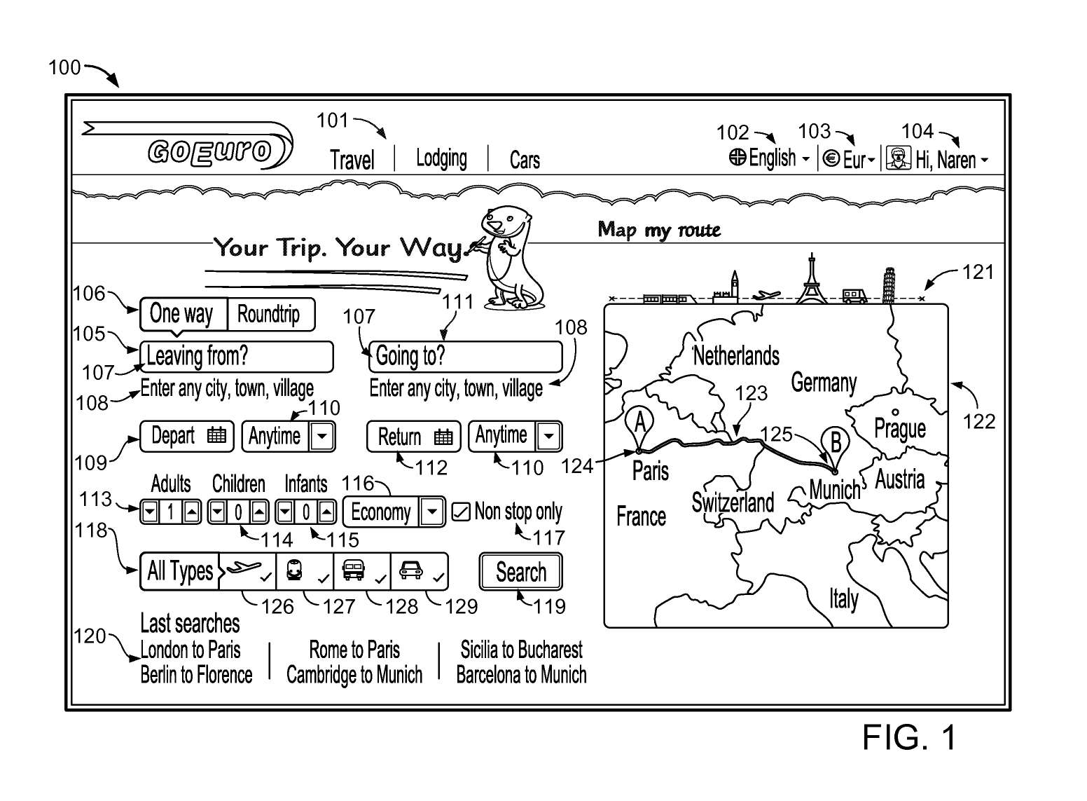

FIGS. 1-4, 6, and 13 are screenshots.

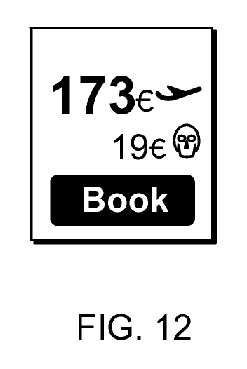

FIGS. 12, 14 through 18, and 20 are portions of screenshots.

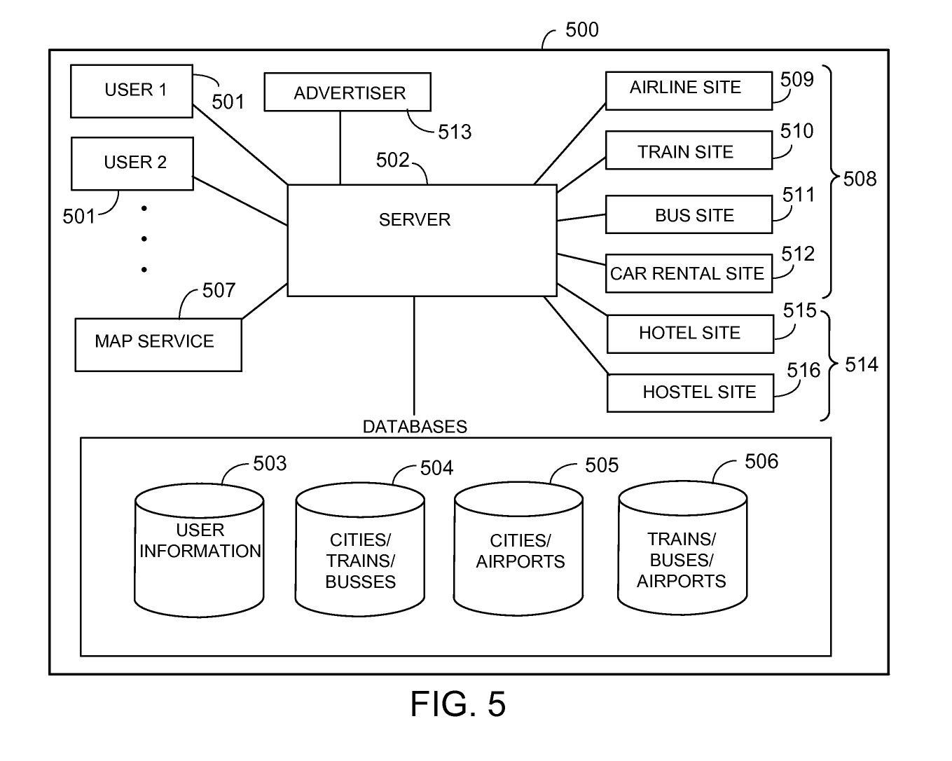

FIG. 5 is a block diagram of online travel planning.

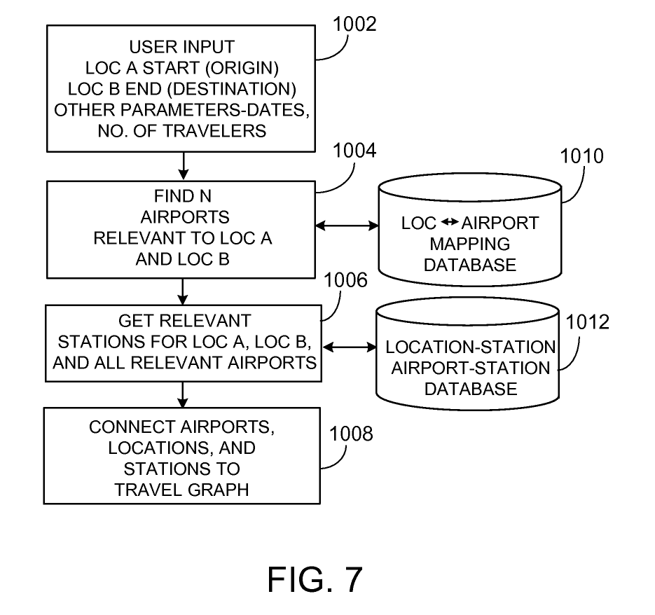

FIGS. 7 and 9 through 11 are flow charts.

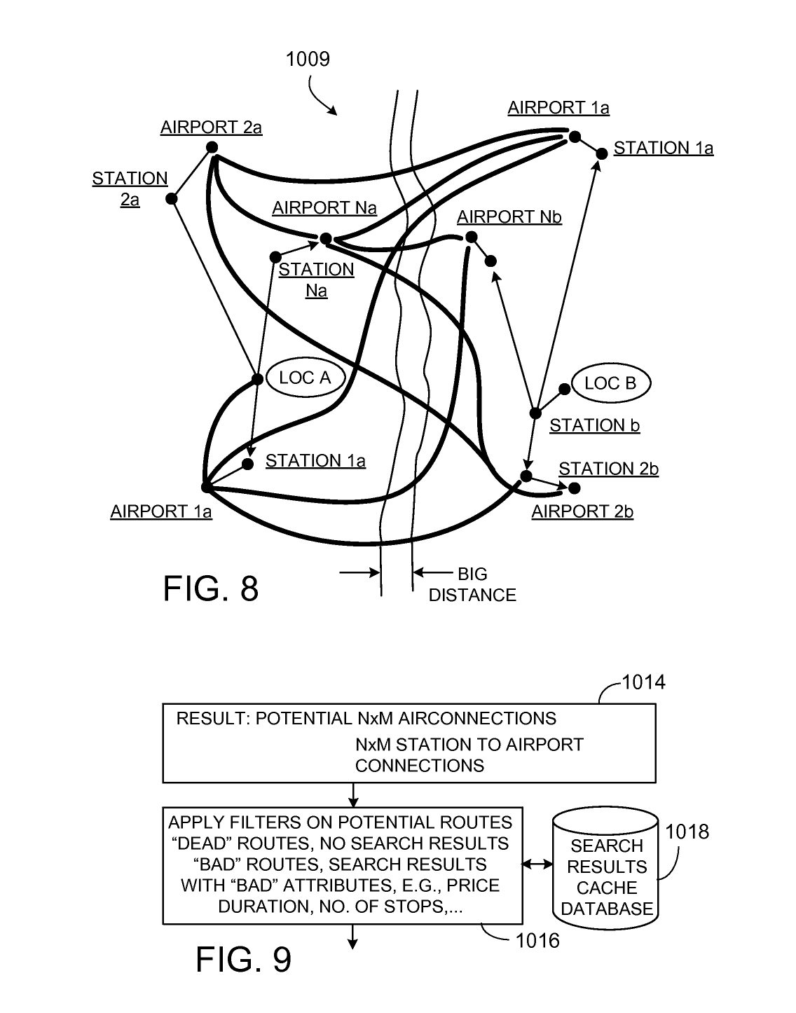

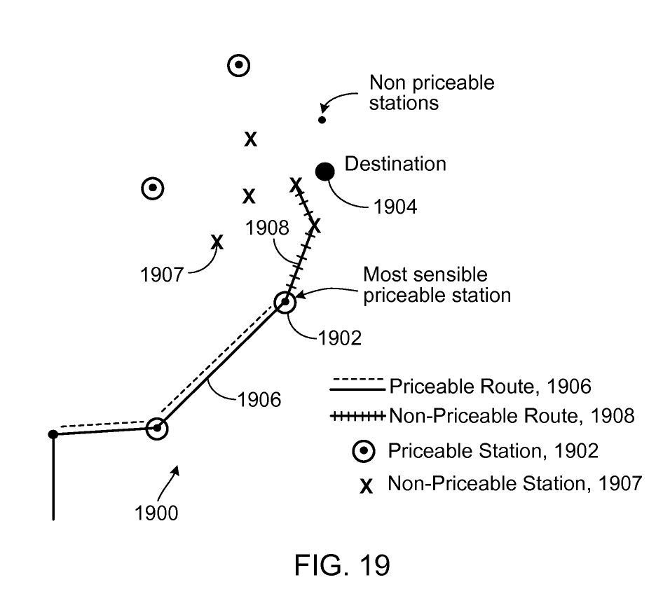

FIGS. 8 and 19 are travel graphs.

Here, we describe an online travel planning system and techniques that can be used, in some examples, to plan a trip that includes two or more modes of travel, such as plane and train and others and presents travel options (a travel option being, for example, a sequence of one or more successive segments using respective travel modes that together will accomplish the planned trip) based on user input and pricing and geographic data. Among other things, the travel options can be compared with respect to elapsed time for the trip and cost, and travel options that have favorable cost (options that we sometimes refer to as relevant options) can be presented. In some implementations, the online travel planning system and techniques are implemented as a website.

Two important components of the system that we describe here by way of example are an interactive site and a travel planning engine. At the interactive site, users can provide and be presented with information concerning travel planning. The travel planning engine includes, among other things, search capabilities and algorithmic features that enable useful travel planning options to be derived from a larger set of possible options based on information provided by the user through the site and on information obtained from other sources.

In our description, we provide details about particular examples of a user friendly interactive site and particular examples of the travel planning engine. These are examples only and a wide range of other kinds of interactive input devices, including mobile apps and other websites could be used. The interaction can be provided in a wide variety of contexts including interaction directly with a person who is going to take a trip and also interaction between businesses (B2B), and interactions between machines, software, or processes not involving human beings. Information can be received or delivered by the system that we are discussing either directly or through an API or by a data feed or in a wide variety of other ways. We use the term interface in a broad sense, to include data feeds, APIs and any other way of passing information to and from the travel planning engine.

Also, a wide range of other kinds of travel planning engines could be used. In particular implementations, the examples of websites that we provide here could be used with a wide variety of travel planning engines in addition to the ones described here. And the examples of travel planning engines that we provide here could be used with a wide variety of interactive sites or applications in addition to the ones described here.

We use the term “user” broadly to include, for example, not only individual people but also groups and institutions, and also another system that uses the results generated by a travel planning engine for further processing and use in other applications.

We use the term “trip” broadly to include, for example, a trip that has a single origin and a single destination such as a trip from a location A to a location B, and also a multiple segment trip such as one from locations A to B to C to D to N and returning to A.

In some implementations, as shown in FIGS. 7 through 11, a travel planning engine implements an algorithm that can be used to develop, analyze, and present options for a trip.

In some cases, the algorithm assumes that users want to travel from one location to another location (we sometimes refer to them as origin and destination), that can be any locations at all. The locations may include city centers or any addresses at all, and need not include airport locations. In other words, a user has an origin and destination in mind that can be any places, for example, city centers or in some implementations any addresses. In such a context, existing travel planning searches for air connections between airports have limited usefulness and comprehensiveness because they typically don't help travelers to understand from which airport near to their departure location to which airport near to their destination location may provide the cheapest or best flight available or a combination of those. They also don't typically optimize total travel time as distinct from the best price.

One aspect of the system that we describe here is based on the premise that searching and analyzing alternative options for a trip that include N closest (relevant) airports from a departure location and the M closest (relevant) airports to an arrival location will yield desirable flight options. The ability to present these desirable flight options is aided by adding train or bus segments to the airports based on access to good train and bus data sources.

Thus, one feature of the travel planning engine is in selecting what we call a “relevant” airport or station that is associated with the origin or destination location of the trip. We may sometimes refer to the relevant airport or station as the closest airport or station or vice versa. The term relevant is meant to refer broadly to, for example, any airport or station that has a satisfactory or desirable relationship to a location with respect to a trip that is being planned. Whether the airport or station is relevant can be measured by a variety of parameters. One parameter that could be used would be distance. And distance can be measured in different ways, for example, distance as the crow flies, road distance (in km), train travel distance (in km), other transport mode distance (ferry miles or other measures) (in km), time distances (which can produce different results than geographic distances) for different travel modes, price “distances” for different travel modes, and by any combination of two or more of those and other factors. For example, the crow-flies distance from Lece (Southern Italy) to Flores (Albania) is 200 kms, but the road distance is more than 2000 kms. In addition to measures of relevance, selection of relevant airports or stations can also involve applying rules that exclude some airports or stations for other reasons, as explained in more detail later.

As shown in FIG. 7, a first step in a process in some implementations of the system that we are description can involve getting user input 1002 through a user interface.

The user selects his origin and destination locations. Each of them need not be (and in this example is not) an airport but rather a location such as a city or town (which may be thought of as the city center or town center) or an address or other location. Through the user interface, the user provides the system with additional information (that will be used by the travel planning engine) such as dates, a number of travelers, whether the trip is to be one way or round trip, and other items.

In a subsequent step 1004, the system uses the indicated origin and destination locations to search in a location-airport mapping database 1010 for relevant airports. If we call the locations A and B, the system can search for N airports relevant to A and M airports relevant to location B.

The database 1010 (which is used by the travel planning engine) contains for each possible origin and destination location a mapping from the location to the relevant airports. A wide variety of measures of relevance of airports to locations is possible. One measure is road distance. Thus, the N most relevant airports to a location can be determined by first conducting a radius search (direct distance “as the crow flies”) for some number P (P>N) of closest airports to location A. Then, to increase accuracy and to automatically solve the “island problem” (see below) the travel planning engine can calculate for all P airports a road distance and can map the N closest (by road distance) airports to a location from among the P candidates.

To accommodate the so-called island problem (in which an airport is close to a location but not easily reachable from that location (e.g., they are separated by water), that mapping (the airport, that is) is removed from the list of candidates. Relevance can also be based on past search results and cached data which is indicative of relevant airports or stations. Also, if a specific route provides no flight connections or very high priced options, the travel planning engine can remove the relevance of a particular airport to the location based on the origin and destination selected.

In a subsequent step, the travel planning engine of the system (we sometimes use the word system in referring to the travel planning engine) finds relevant stations to the N airports that are candidates for the origin location and the M airports that are candidates for the destination location. The system searches in a location-to-station database and a station-to-airport database 1012 for relevant stations for location A, location B, and all relevant candidate airports from step 1004. We use the term station broadly to include, for example, a transport stop of any mode of transportation (train, bus, ferry, and others) except (generally) airplane.

In a subsequent step 1008, the system creates a travel graph 1009 as shown in FIG. 8. To generate the travel graph, which is basically a mapping of relevant airports to each of one or more specific location along with train and bus connections to those airports from the locations, the travel planning engine connects each of the N departure airports with each of the M destination airports, to form N×M possible air routes. The engine connects a station associated with origin location to the stations that are associated with the departure airports, which produces N route segments at the origin end of the trip. The engine also connects the station at the destination location with each of the associated stations of the respective arrival airports, which produces M route segments at the destination. Although the travel graph has been shown graphically in the figure, in some implementations, there is no actual graphical representation created and when we refer to the travel graph we include the database entries and related analysis and the resulting conceptual travel graph.

The result is a set of N×M potential air connections and M+N station to airport station connections 1014. Additional analysis is applied to avoid routes that make no sense.

For example, a search that would have the same destination airport and arrival airport is excluded. If a departure airport is closer to the arrival location then to the departure location, it is excluded from the departure location mapping. If an arrival airport is closer to the departure location then to the arrival location it is excluded from the arrival location mapping.

If the distance between location A and location B is shorter then some number X kms, the airport search is disabled.

In a subsequent step 106, filters are applied to the potential routes. For example, the routes are filtered to exclude: dead routes that don't give any search results, and bad routes that give only results that have some attributes with unacceptable values like too high a price, too long a duration, or too many stops.

In some cases, the travel planning engine achieves this filtering by looking at previous search results in a search results cache database 1018.

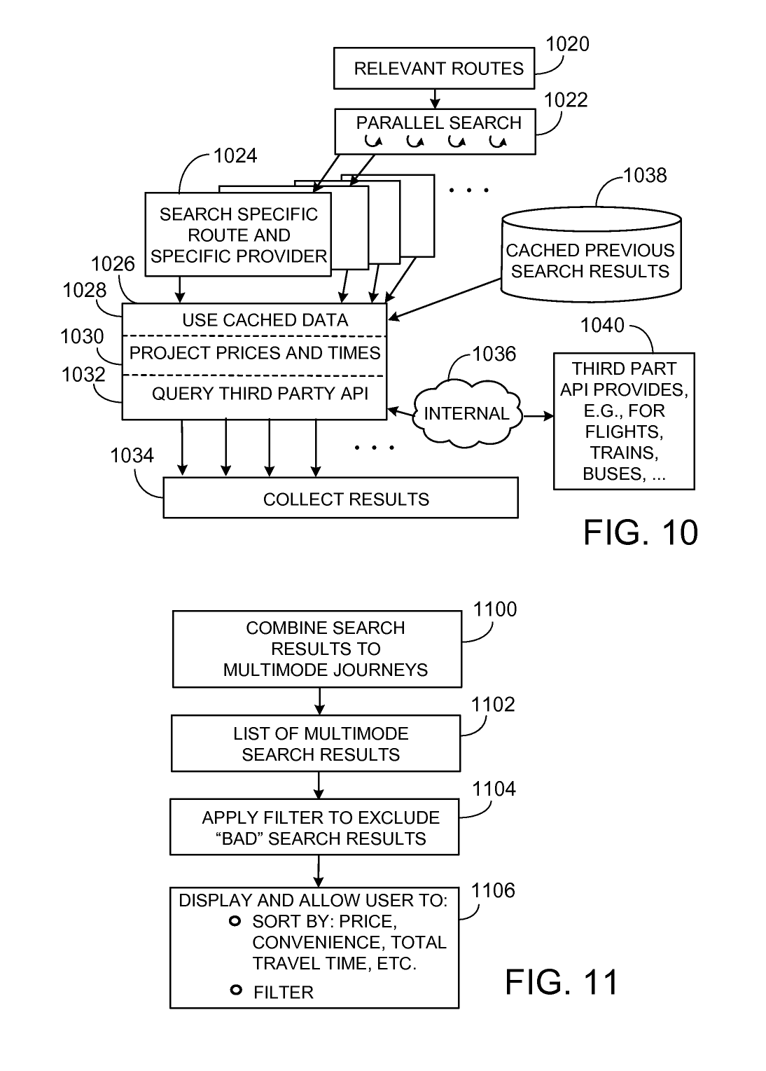

As shown in FIG. 10, the outcome of the filtering step is a list of relevant routes, that is, routes that are relevant to the preferences of the user and are sensible. By a route we mean a series of segments of travel by one or more modes that lead from the user's origin to the user's destination and that may pass through stations and include air segments between airports. With respect to routes, we use the term relevant in a broad sense similar to the use of the term relevant with respect to airports or stations to mean, for example, routes that are satisfactory, of interest, desirable, or in some other way relevant to the trip being planned. A wide variety of measures can be used to gauge relevance of routes to a planned trip.

Once the set of relevant routes have been determined, searches are performed to find scheduled segments that may be available from various travel providers for each of the segments of each of the relevant routes. Each segment may be served by more than one provider. Each provider's route data can be searched for scheduled trips that match each segment of each relevant route.

Searches can be performed in parallel 1022 of the various travel providers schedule data in order to provide a fast user experience. For each relevant route from 1020 parallel searches 1024 are executed for each travel provider that serves that route.

Depending on the provider and the frequency with which search results for the provider may change, the system uses cached data 1038 from prior searches to reduce the intensity of queries 1032 made through third party APIs 1040 to third party schedule data. When cached data 1038 is outdated, queries are made to the APIs.

In order to provide fast results and limit the amount of use of resources of data supplying partners and overload on the system, the engine can implement smart caching.

Some providers (especially train and bus) do not provide an API. In such cases, their entire schedules are held internally 1036 within the system databases that are used by the travel planning engine.

Some travel providers (for example, bus and train) only provide trip and connection information for fewer than all of the trips operated each day. For example, they may provide price and times for only ten train connections for a certain route for a given day even though they provide service on the route on that day many more then those ten times. In order to limit the queries the system makes to the train provider, we use an algorithm to project 1030 unknown (to our system) times and prices

In some examples, the algorithm of the travel planning engine part of our system can take the known (to us) data, look for a pattern in pricing and times, and project these times and prices to all periods throughout the day or the following day.

If the same route is requested again the engine can request another time block for the provider during the day and with this data we increase the accuracy of our projection.

As mentioned, in cases for which the cache doesn't give results or where search results change frequently, we query the third-party API 1038 and put the results in the cache 1038.

In a subsequent step 1034, we wait for the search results to come back (within a defined time frame).

As show in FIG. 11, once the search results have come back or after the defined time frame is past, we combine search results to form possible multimode journeys 1100.

According to the routes that had been the basis of the searches and based on the timetables for segments of the journeys, we combine the search results to produce a list of multimode search results for each of the relevant alternative itineraries from the origin to the destination.

In a subsequent step 1104, we apply filters. Among other things, the filters can exclude search results if their attributes have unacceptable values such as too high a price, too long a duration or too many stops, for example.

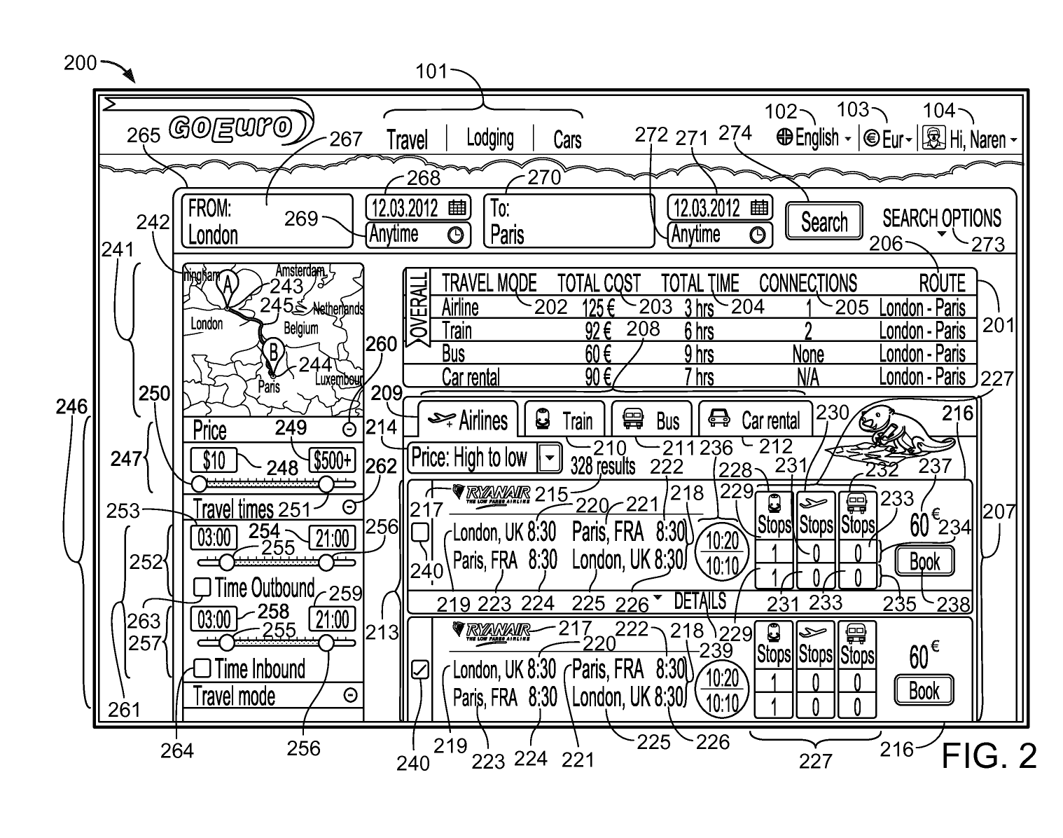

As shown in FIG. 2, for example, the filtered list can then be displayed to the user 1106 as sorted by certain criteria. The user can then filter and re-sort the list.

In some implementations, the location that is the origin or destination cannot be any address but can only be a city, town or village that has a name and known geo-coordinates. In some implementations, the origin or destination could be any address.

For example, a user may want to travel from an origin in Edinburgh, UK, to a destination in Compiegne, France, including a segment in which the travel mode is plane, but may not know or want to figure out manually which airports are relevant to the origin and destination, which other segments there are in which travel modes will need to be included in travel options to be considered, what the costs of different options would be, or how to book the segments once the best option is chosen. In some examples of the interactive site, the user can specify to the system travel modes that are of interest for the trip, including not only air and car, but also train, bus, and water, among others. The user can specify to the site that he wants to plan a one-way trip or a round trip. The user can choose an origin and a destination for the trip by specifying a city, town, or village, or even a specific street address and house number.

In some examples, the user can, on the website or mobile app or other user interface, specify travel dates and times of day, a number of travelers, broken down among adults, children, and infants, and a preference for non-stop travel, among other things. The user is shown a graphic summary of the origin and destination and an approximate travel route for the trip between the two points. If the user has previously used the online travel planning site, a collection of the user's previous origins and destinations can also be shown. Individual items of this collection can be selected as shortcuts for choosing origins and destinations. The site can be configured to display text in various languages and display costs in various currencies, based on the user's choice. When the user has finished entering this travel information, the user can initiate a search for travel options that conform to the entered information, can choose a preferred travel option, and can then have the site book the segments of the trip that correspond to the chosen travel option and keep the user informed of the booking status.

In some cases, the online travel planning site or the server side of the mobile app and the travel planning engine are hosted on a server or set of servers and one or more databases of information related to possible segments of trips, including cities that have train stops or bus stops, are managed by the server or servers. As discussed above, the database can associate each location, which can range from an individual address or a small village to a big city, with the relevant three (or some other small number of) airports by road distance or travel time or some other measure of proximity. The database can also maintain information about all train stops and bus stops (which can be thought of as bus “stations” for some purposes of our discussion) for each location and at its associated nearest airports. The nearest train stations and bus stops for each location and each airport are calculated using latitude and longitude coordinates (also known as geo-centric coordinates). The method of mapping is sometimes called “Geo Centric Mapping Technology.” As mentioned earlier, in some implementations the mapping is determined based on relevancy as measured by any of a wide variety of parameters and rules and combinations of them.

In the Edinburgh to Compiegne example, the system will use the database to identify the relevant airports to Edinburgh, which are Edinburgh airport and Glasgow airport, and the relevant airports to Compiegne, which are Paris CDG and Paris Orly. The search engine will then determine all flights from Glasgow and Edinburgh to Paris CDG and Orly using data drawn from sources that list flight information. The search engine will also search for trains and buses between Edinburgh and Glasgow, and between Paris CDG or Orly and Compiegne. The search engine will also search for available train, bus, and rental car segments from Edinburgh to Compiegne directly that do not require use of an airplane segment and if needed will combine segments provided by different train operators to piece together the journey. The search engine or site will estimate the travel times and the prices of the individual segments of the trip and the aggregate of the segments. The site displays a user friendly format of the results in a summary table and a tabular display, with the ability to drill down into the results and visually compare a subset of the results. Filters can be used extensively to filter down options easily for a customer to pick the one he prefers. The user can book the trip directly from this display.

After the engine searches and analyses the possible segments that make up one or more travel option for the trip, the engine generates and provides a summary table (201 in FIG. 2) for display through the user interface. The summary table shows a breakdown of the results in rows by travel mode. Each summary row displays a total cost, a total travel time, the specific route and a number of connections. A tabular view displays all of the results by row within each mode. Each row shows details about a carrier.

For example, if the airline tab of the web site is chosen, each row shows: a name of the airline; airports used; departure and arrival times of each flight; a number and type of connections (segments), and the train, bus, or car connections to the airport; a cost; and a button to press to book the flight or the train and bus connections. The user can expand a row to display additional details about the modes associated with that row. For example, an airline flight result might require a traveler to first take a train segment to reach the airport. This expanded display will show this train segment, with duration, wait time, and train number. From this view, the user can book these segments separately or can have the site do the bookings.

The user can filter the travel option search results by: travel mode; travel duration, both outbound and inbound; price; number of stops; convenience (based on a variety of possible metrics, for example, an estimated ratio of the total price to the total travel time weighted according to the length of the journey); class of travel; and preferred carrier within a travel mode or preferred airport or train stations based on proximity to their location and based on price vs. travel time; and individual preferences. The user can sort the results by different factors such as total cost or total duration. The user can also choose to view a subset of the results from one or more travel modes to easily compare different options based on travel criteria of importance to that user. For example the user may want to choose a less expensive, longer duration option over a more expensive, shorter duration option.

The user also can book lodging through the online travel site. The site will enable the user to compare lodging options (for various lodging modes) simultaneously such as hotels, hostels, and individual apartment rentals (such as Airbnb and 9Flats). The easy comparison of the different accommodation options of hostels, individual apartments, and hotels will also include a simple user interface with the tabular form for each segment, along with a summary table and easy filtering. This also includes a large map view where the different lodging options are mapped using color codes or other means of unique identifier for visual comparison of proximity of each of the options to various locations within a city.

The user can compare car rental options for any segment of the trip. The site will obtain a price per day for car rental options and use a mapping service to determine driving distances and average driving speed to estimate the travel time and cost.

In one example of such an online travel planning user interface, as shown in FIG. 1, a travel planning screen 100 shows controls that govern the use and operation of the system, the interface, and the engine. A user context control 101 enables the user to select a travel planning mode, that is, to indicate if she is planning travel, finding lodging, or renting a car. A language control 102 shows the current language used on the site and can also be invoked to change the language. A currency control 103 shows the currency in which pricing is displayed and can be used to change the currency. An account control 104 shows information about the user of the site and provides access to other information about the user's account.

When the screen is in the travel planning mode, a user provides information about his travel plans by interacting with controls on the travel planning screen 100. He enters his origin in the origin box 105. A label 107 explains to the user that the origin box 105 is for entering an origin. A label 108 shows the type of information to enter, here, a city, town, or village (and possibly an individual address). A destination box 111 is used for entering a destination. A label 107 explains that the destination box 111 is for entering a destination. A label 108 shows the type of information to enter, here, a city, town, or village. A trip type control 106 is used to choose a one-way trip or a round trip and displays the current choice.

The user provides a date and time of the trip using controls on the travel planning screen 100. The day and time to begin the trip are chosen using a departure date control 109 and a time control 110 (the latter of which defaults to a value of “Anytime”). The day and time of day to return are chosen using a return date control 112 and a time control 110 (which defaults to “Anytime”).

The user names the passenger and travel preferences using controls on the travel planning screen 100. The user manipulates controls 113, 114, and 115 to specify respectively numbers of adults, children, and infants traveling. The defaults are 1, 0, and 0 respectively. The user specifies a class of travel using a travel class control 116 (default “Economy”), a preference for non-stop travel using a non-stop travel control 117 (defaults to non-stop), and acceptable modes of travel using a travel mode control 118, (default all modes).

An important feature of the interface and of the capabilities of the system is that subsets of modes of travel can be chosen using checkboxes that include a plane mode of travel control 126, a train mode of travel control 127, a bus mode of travel control 128, and a car mode of travel control 129. A user can choose any one or any two or more of any of these modes. For example the user could check bus, car, and train, but not plane, or any other combination. In some implementations, other modes, for example, bicycle, water, and others, could be included or one or more of the modes shown in FIG. 1 could be removed or both.

A travel planning map control 121 that includes a travel planning map 122 on the travel planning screen 100 graphically displays locations on a map corresponding to values entered by the user in the origin box 105 and the destination box 111. A trip origin is indicated by a trip origin pin 124 on the travel planning map 122 in the travel planning map control 121. A trip destination is indicated by a trip destination pin 124 on the travel planning map 122 in the travel planning map control 121. A travel route approximation 123, which graphically provides an overview of the trip, is displayed on the travel planning map 122 in the travel planning map control 121. A wide variety of other features can be included in the mapping device, including display of the airports close to a location, or train stations in proximity of the location, and others.

Once the user has entered travel planning details—which include the origin, destination, day and time, number and types of passengers, travel class, preference or not for non-stop travel, acceptable modes of travel, and possible bonus or reduction programs.—he causes the travel planning engine to search for matching itineraries using a travel planning search button 119. An itinerary is a complete representation of one trip option from the origin to the destination that includes all segments of the trip, where each segment has an associated travel mode and carrier, day and time, and, where applicable, a carrier number (such as a flight number for plane mode). Previous searches are displayed by a previous searches control 120. The user can also use the previous searches control 120 to invoke a previous search.

As shown in FIG. 2, in some implementations, a top portion of a travel planning result screen 200 displays results of the search invoked by the travel planning search button 119 in FIG. 1. Another important feature of the interface and of the capabilities of the system is the summary table 201. The summary table 201 displays a summary of the results (that is, travel options) in rows using a travel mode column 202, a total cost column 203, a travel times column 204, a number of connections column 205, and a route column 206. Each row in the summary table 201 corresponds to a mode of travel displayed in the travel mode column 202, including airline, train, bus, and car rental in this example. This table and arrangement of display provides a very simple user experience that enables the user to easily know the total price and total cost to get from Location A to Location B within a single view with information on all modes of travels found either directly or by a combination of the modes of travel. Additional rows in the summary table showing multi-mode or ferry options could also be included. The total cost column 203 displays the price for each travel mode in the specified currency. The total time column 204 displays the duration of each segment of the trip. The number of connections column 205 displays the number of connections required in each mode of travel. The route column 206 contains a textual description of the origin and destination of the trip.

A simple user interface in the form of tabular mode results display 207 shows the details of each type of travel mode. A set of results tab controls 208 indicates which travel mode is displayed in the rows of the tabular mode results display 207 and is used to switch modes. The set of results tab controls 208 includes an airlines+tab control 209 (The airlines+tab also always includes travel modes or public transportation routes to get between the origin location and the departure airport and between the arrival airport and the destination location), a train tab control 210, a bus tab control 211, and a car rental tab control 212 in this example. The airlines tab control 209 is highlighted indicating that airlines result details 213 are displayed. A tabular results sort control 214 is used to order the airlines result details 213. An ordering from high price to low price is shown in the tabular results sort control 214 and a label 215 shows the number of search results for the current travel mode. The tabular results sort control 214 changes the ordering of the results.

An airline detail row 216 shows detail about one airline travel result. An airline logo 217 shows the airline corresponding to this result. An airline timetable 218 shows an origin location 219, an origin flight time 220, a destination location 221, and a destination flight time 222 for an outbound portion of the trip. The airline timetable 218 also shows a return origin location 223, a return origin flight time 224, a return destination location 225, and a return destination flight time 226 for an inbound portion of the trip. A connections (or segments; we sometimes use the terms connections and segments interchangeably) travel mode display 227 shows connections to (segments of) other modes of travel for the trip, organized by outbound and inbound trip segments and travel modes. Shown are train connections 228 and train connections stops 229, airlines connections 230 and airlines connection stops 231, and bus connections 232 and bus connections stops 233. The number of stops is displayed in a top row 234 and a bottom row 235 corresponding to the outbound portion of the trip and the inbound portion of the trip, respectively. A connection time display 236 shows the time of day of the first connection following the outbound and inbound flights. The connection time is for the flight times and not the total travel time including train and bus segments. A price indicator 237 (another example of which is shown in FIG. 12) shows elements of the cost of this portion of the trip using this mode of travel. The price indicator shows in a larger font size the price of the main mode with an icon indicating that mode, and shows in a smaller font size the price for train or bus airport connections within an icon indicating the mode.

The price indicator is displayed in the selected currency.

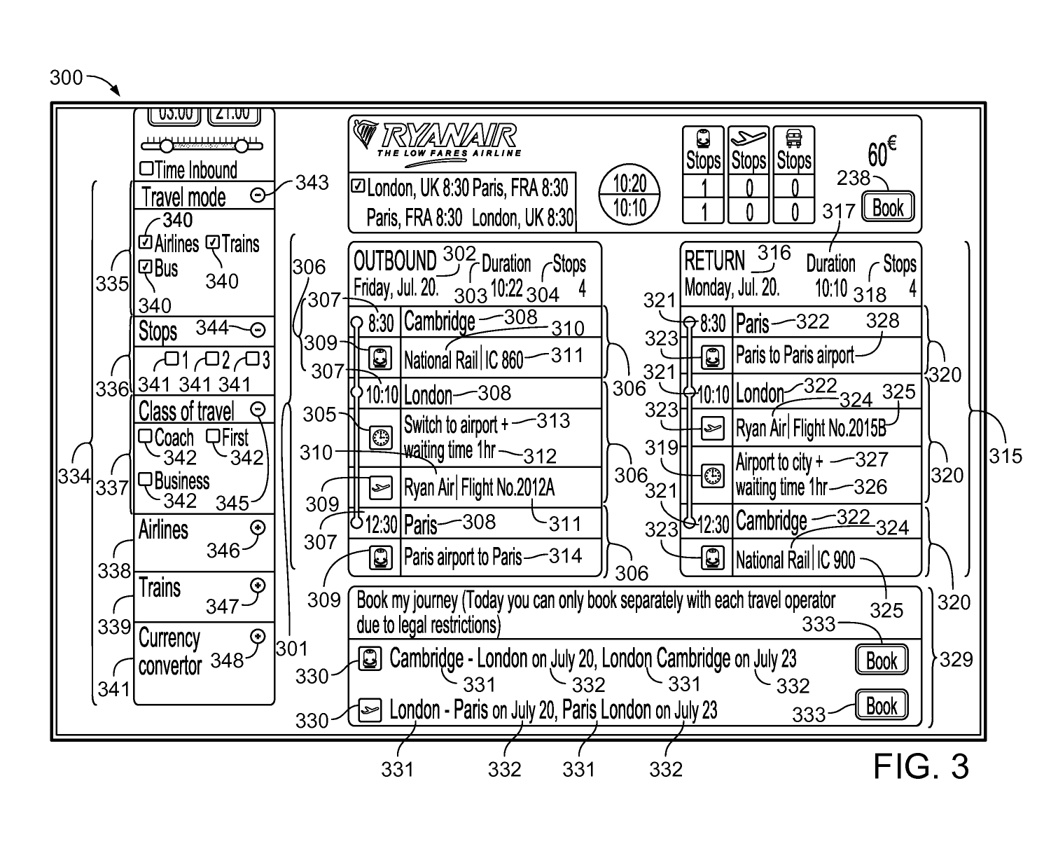

Once the user is satisfied with a presented itinerary, he uses a booking button 238 to book the travel. In some implementations, the booking information is sent to partners to make the actual bookings such as Opodo or Expedia for air and Deutsche Bahn for trains. In some implementations, the bookings could be done by a module of the travel-planning engine so that the travel planning and booking processes are combined. The user need not do the bookings for the various modes and segments of the trip himself; rather he need only click the booking button and the system makes all of the reservations for all modes and segments for him. The user can activate the details expander 239 to display trip details combining modes of travel, described in FIG. 3. A tabular result row checkbox 240 is used to add selected item to a comparison table. The comparison table is a feature in which the user can easily compare different modes of travel in a simple comparison format similar to that of comparing cameras A search results map display 241 shows a graphical overview of the trip on a search results map 242, and shows a search results origin pin 243, a search results destination pin 244, and a trip route travel approximation 245.

The user can filter the search results by manipulating filter controls 246. A price filter control 247 displays a current range of prices from a low price shown by a low price range display 248 to a high price shown by a high price range display 249. The price filter control 247 is also used to change the price range to display results with prices within a different price range. The user drags a low price slider button 250 or a high price slider button 251 or both to change the price range. The low price range display 248 and the high price range display 249 change to display the new low price and high price, respectively. A price filter detail control 260 is used to expand or collapse the details for the price filter control 247. Here, the price filter control 247 is shown expanded.

A travel times filter (which can also be termed a departure time filter for outbound and return journey) section 261 displays an outbound time filter control 252 and an inbound time filter control 257. The outbound time filter control 252 displays a current range of times, from an earlier time shown by an earlier outbound time range display 253 to a later outbound time shown by a later outbound time range display 254. The outbound time filter control 252 is also used to change the outbound time range to display results of outbound times within a different time range. The user drags the earlier time slider button 255 or the later time slider button 256 or both to change the outbound time range. The earlier outbound time range display 253 and the later outbound time range display 254 change to display the new earlier outbound time and later outbound time, respectively.

The inbound time filter control 257 displays a current range of times from an earlier inbound time shown by an earlier inbound time range display 258 to a later inbound time shown by a later inbound time range display 259. The inbound time filter control 257 is also used to change the inbound time range to display results with inbound times within a different time range. The user drags the earlier time slider button 255 or the later time slider button 256 or both to change the inbound time range. The earlier inbound time range display 258 and the later inbound time range display 259 change to display the new earlier inbound time and later inbound time, respectively. The travel times filter section 261 is shown here expanded by a travel times filter section detail control 262.

A trip header control 265 contains a search result trip origin box 267 that displays the origin of the trip and provides a new trip origin if the user chooses a new search. A search result origin date control 268 displays the date of the origin of the trip and provides a new origin date if the user chooses a new search. A search result origin time control 269 shows the time of the origin of the trip, here, “Anytime” and provides a new origin time if the user chooses a new search. A search result trip destination box 270 displays the destination of the trip and provides a new trip destination if the user chooses a new search. A search result destination date control 271 displays the date of the destination of the trip and provides a new destination date if the user chooses a new search. A search result destination time control 272 shows the time of the destination of the trip, here, “Anytime” and provides a new destination time if the user chooses a new search. An additional search options control 273 is used to select additional options for a new search. The travel planning new search button 274 is used to run a new search based on the values in the trip header control 265 and the additional search options control 273.

As shown in FIG. 3, a bottom portion of a travel planning result screen 300 displays results of the search invoked by the travel planning search button 119 in FIG. 1 and activating the details expander 239 in FIG. 2. An outbound itinerary details display 301 shows segment details of an outbound portion of the trip. Shown are a date 302, a duration 303, and a number of stops 304 for this portion. Shown are one or more outbound segment details 306, each outbound segment detail 306 showing a beginning time 307, an origin 308, a carrier type icon 309, a carrier name 310, and a carrier number 311. If there is a waiting time between segments, the outbound segment detail 306 shows a waiting icon 305, a duration of the waiting time 312, and a connection information 313. The display elements show the total journey. In one use case, if the system finds a train or bus from a departure location or an arrival location to and from the respective airports, it shows the train details (with carrier name 310 and 311) to the airport, plus a waiting and check-in time of n hours (n might be defined by the users preferences or by the host of the system based on user surveys; for example the time could be set at 1.5 hours) and then the actual flight details. In another use case, if the system does not find a train or bus to the airport, the interface shows a “Car” or “Public Transportation” or “Find other trains” option where a user can choose to drive to the airport, or take public transportation (This is a clickable link for which the system provides its own content—this is inner city travel 314) or starts a new train-only search to the specific airport. Instead of the carrier name 310 and the carrier number 311, a local inner-city travel mode 314 can be displayed.

A return itinerary details display 315 shows segment details of a return portion of the trip. Shown are a date 316, a duration 317, and a number of stops 318 for this portion. Shown are one or more return segment details 320, each return segment detail 320 showing a beginning time 321, an origin 322, a carrier type icon 323, a carrier name 324, and a carrier number 325. If there is a waiting time between segments, the return segment detail 320 shows a waiting icon 319, a duration of the waiting time 326, and connection information 327. Instead of the carrier name 324 and the carrier number 325, a local inner-city travel mode 328 can be displayed.

Instead of booking an entire trip using the booking button 238 the user can book carrier specific segments of the trip using a segment booking display 329, which displays a carrier icon 330, a segment origin and segment destination 331, and a segment date 332. The user activates a segment booking button 333 to book that segment. The book button 238 may either present the details of the journey so that the user can book individual legs, or may trigger the system to book the entire journey on behalf of the user, or a combination of the two.

Additional filter controls 334 for limiting search results include a travel mode filter 335, a stops filter 336, a class of travel filter 337, an airlines filter 338, and a trains filter 339. The travel mode filter 335 contains checkboxes 340 corresponding to travel modes such as airlines, trains, and bus (and others could be included also) to filter the results by travel mode. The stops filter 336 contains checkboxes 341 or may include a slider to filter the results by the number of stops. The class of travel filter 337 contains checkboxes 342 to filter the results by class of travel including coach, business class, and first class. The airlines filter 338 filters the results by airline carrier. The trains filter 339 filters the results by train carrier. In some implementations, other filters could be included or removed or both. A currency converter tool 341 allows the user to determine current currency exchange rates. The currency converter is a simple way to explore currencies if a user needs to, instead of changing the prices on the entire page from the currency button on top header panel. The user manipulates controls 343, 344, 345, 346, 347, and 348 to expand and collapse details of the travel mode filter 335, the stops filter 336, the class of travel filter 337, the airlines filter 338, the trains filter 339, and the currency converter tool 341, respectively. The filters are often used to nail down the result according to a user's own preferences based on the many options the engine is able to find by combining modes of travel or by independent modes of travel.

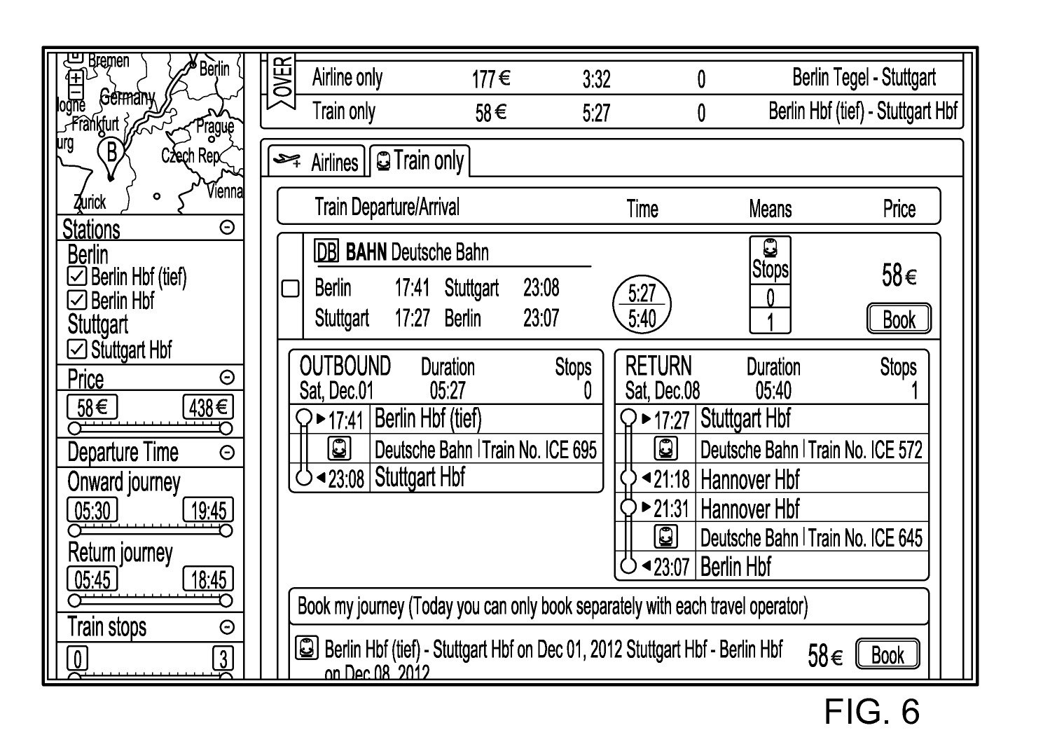

The train-only and bus-only tabs work somewhat differently from the airline+tab. For display in the train-only and bus-only tabs of the user interface, the travel planning engine puts together an entire journey using only train or bus, either using a single train (bus) operator or by combining multiple train (bus) operators. The filters will work in a similar way for a user to go from broad train options provided to an exact list of trains he needs. This is illustrated in FIG. 6.

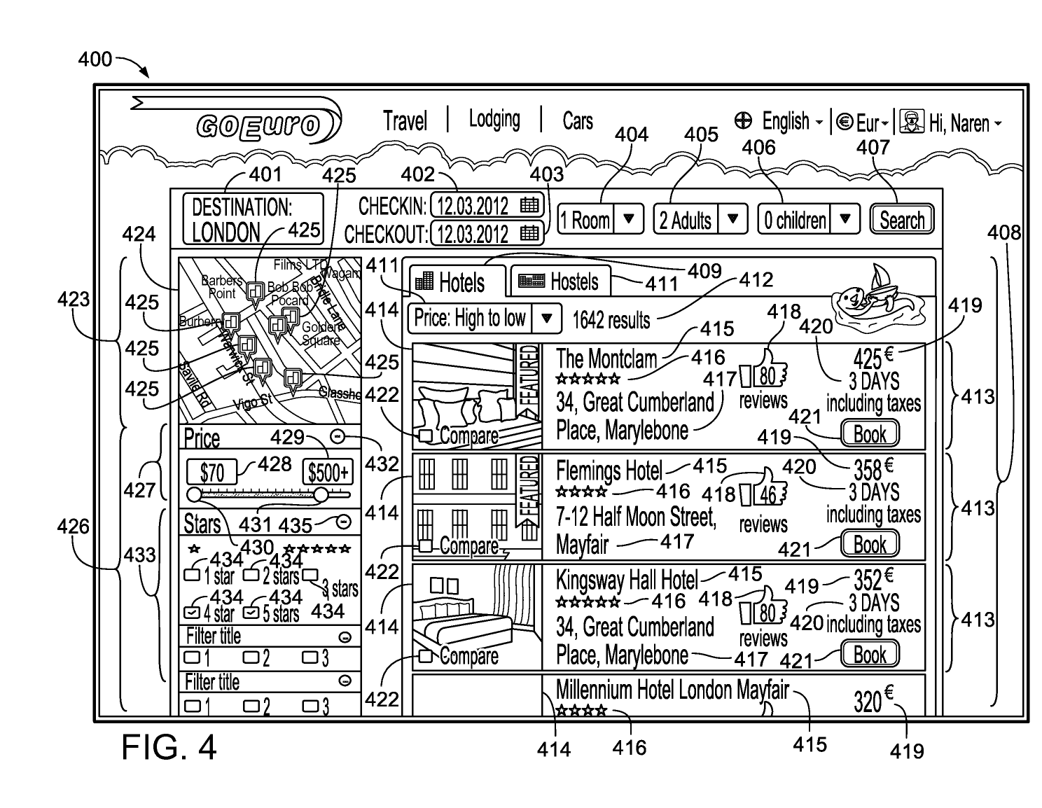

As shown in FIG. 4, the online planning site is illustrated in a finding lodging context and is displaying a lodging planning screen 400. A lodging destination box 401 contains the destination from the current trip. The box 401 is modifiable by the user to provide another lodging destination. A check-in box 402 and a checkout box 403 specify the desired check-in and checkout dates for lodging. A rooms control 404, a number of adults control 405, and a number of children control 406 specify the number of rooms to book, the number of adults who require lodging, and the number of children who require lodging, respectively. A lodging search button 407 is clicked to initiate a lodging search.

Lodging search results are also displayed in a tabular view 408 containing tabs for hotels 409 and hostels 410. In some implementations, other tabs could be included such as local apartments or one or more of the tabs in the tabular view 408 could be removed or both. A sort control 411 orders the results based on a particular factor and sequence, as shown here, by price, from high to low. A label 412 indicates the number of search results. For each lodging search result a lodging result row 413 displays a graphic 414, a name 415, a star rating 416, an address 417, a review graphic 418 (indicating a number of reviews and an overall positive or negative review rating), a cost 419 in the currency selected by the user, a textual duration description 420, and a booking button 421. Each lodging row 413 contains a checkbox 422 to compare subsets of lodging results.

A lodging map control 423 displays a map 424 of an area corresponding to the lodging search results and lodging pins 425 showing a location of a lodging result and a graphic of a lodging type. It will have a feature in which the map view can be expanded to the full screen. This map view also places the different lodging options of hostels, hotels, and individual apartments using colored pins or other unique identifiers on the map for the user to have a better visual experience of the lodging market with respect to geography.

The user can filter the lodging results by manipulating filter controls 426. A price filter control 427 displays a current range of prices from a low price shown by a low price range display 428 to a high price shown by a high price range display 429. The price filter control 427 is also used to change the price range to display results with prices within a different price range. The user drags a low price slider button 430 or a high price slider button 431 or both to change the price range. The low price range display 428 and the high price range display 429 change to display the new low price and high price, respectively. The price filter control is expanded or collapsed with an expander control 432.

A stars filter control 433 displays a current range of star ratings, here from one star to five stars, and stars checkboxes 434 for filtering results by a number of stars. The stars filter control is expanded or collapsed with an expander control 435. In some implementations, other filter controls could be included or one or more of the filter controls 426 could be removed or both.

As shown in FIG. 5, a block diagram 500 of the online travel planning site shows entities associated with the site. A user 501 provides travel planning information to a server 502 which communicates results to the user 501. As shown, multiple users can interact with the server. The site has databases that persistently store travel planning information. A user information database 503 stores account information for each user collected during previous interactions with the site. A database 504 caches associations between cities and the nearest train stops and bus stops. A database 505 caches associations between cities and their three closest airports by road distance. A database 506 caches associations between train stops, bus stops, and airports. The databases 504, 505, and 506 can be populated before the user 501 interacts with the server 502.

When the user 501 wants to plan a trip, the server 502 can present previous travel planning information for the user to choose, fetched from the user information database 503. When the user 501 initiates a search by the travel planning engine after providing travel planning information, the travel planning engine running on the server 502 examines the cache databases 504, 505, and 506 to efficiently calculate itineraries. If information such as a city is not found in one of the cache databases 504, 505, and 506, the server 502 interacts with a map service 507 to retrieve the missing information. The server 502 communicates with a set of travel mode sites 508 including an airline site 509, a train site 510, and a bus site 511 based on preferences specified by the user 501. A car rental site 512 provides an alternative for each segment of the trip. The server 502 receives advertising data from an advertiser 513 to display to the user 501 to generate revenue. The server 502 presents results and advertising data to the user 501 who then can view, filter, sort, and compare the results in a variety of ways. When satisfied with an itinerary, the user 501 can book the trip through the server 502 which interacts with the applicable travel mode sites 508.

The user 501 can book lodging by providing lodging information to the server 502 which interacts with various lodging sites 514 including a hotel site 515 and a hostel site 516 to generate lodging results. The server 502 receives advertising data from an advertiser 513 to display to the user 501 to generate revenue. The server 502 presents results and advertising data to the user 501 who then can view, filter, sort, and compare the results in a variety of ways. When satisfied with a lodging result, the user 501 can book the lodging through the server 502 which interacts with the applicable lodging sites 514.

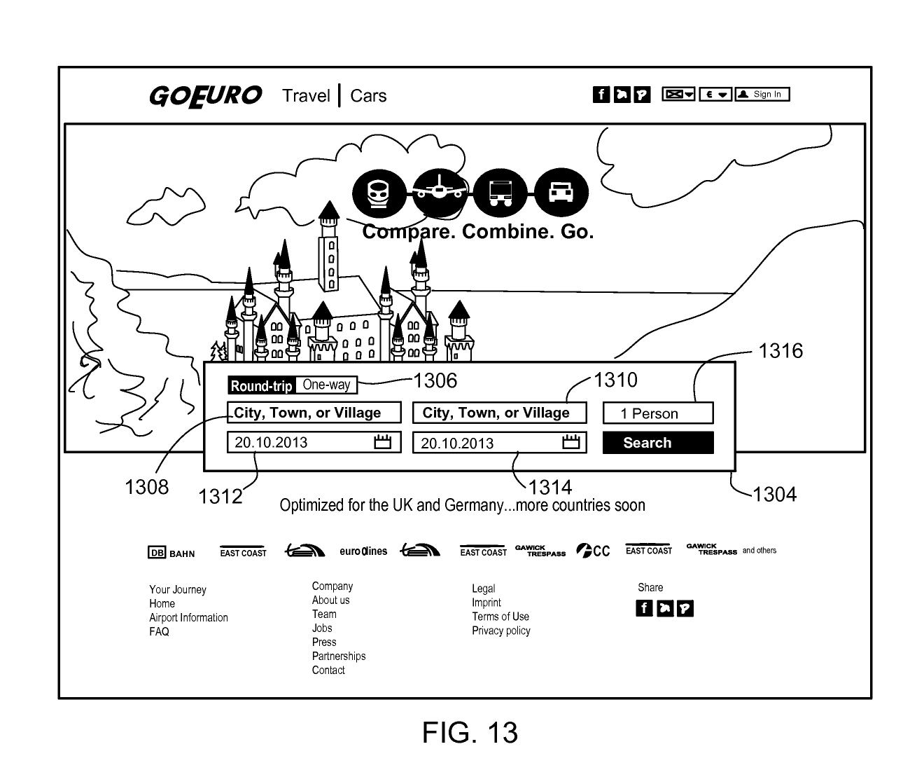

Referring to FIG. 13, a homepage 1302 of the travel planning system exposes to the user a simplified search form 1304 that significantly reduces the (sometimes confusing or overwhelming) options that are made available to a user of a typical travel site. The options provided are to choose between round-trip and one way 1306, to identify the origination location 1308, to identify the destination location 1310, and to specify the number of people traveling.

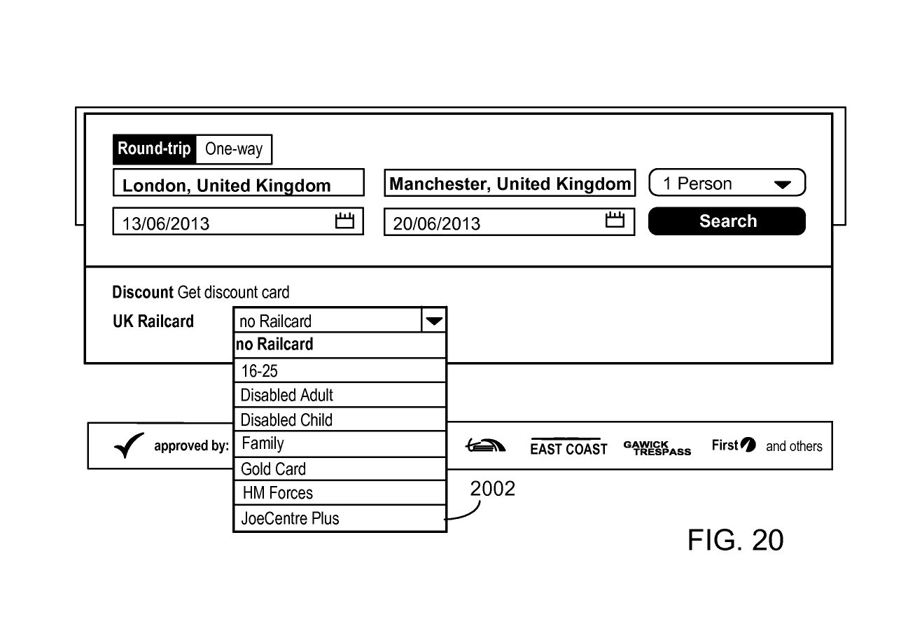

Referring to FIG. 20, providers of travel services often offer discount cards and other promotions for frequent travelers. The availability of such promotions affects the price comparison done by the travel planning system between carriers. The search engine of the travel planning system therefore takes bonus cards of and other promotions available to a user into consideration. Information about such discounts and other promotions can be stored for a known user in the user profile and a database of the system when the information has been provided or can be inferred. But for an anonymous user (e.g., a user whose identity is not known to the system) it needs to be requested by the system from the user for each search or session.

The promotions provided by not every provider will be relevant for every route, for example, if a user is looking for a trip within the UK, it may make no sense to ask him for information about his German rail cards. Accordingly, in connection with the search, the system can constrain the discount cards and other promotions that are considered to promotions offered by relevant providers. The system determines which promotions (e.g., the relevant cards) to be considered based on the departure and arrival locations and can display only a selection of relevant bonus cards to choose from. Referring to FIG. 20, for example, a drop down list 2002 can be invoked by the user. Any other form of selection element could be used. The drop-down list includes the possible options that could be relevant to the trip being considered. For example, as shown in FIG. 20, the user can indicate that he has no rail card or indicate the type or rail card that he possesses.

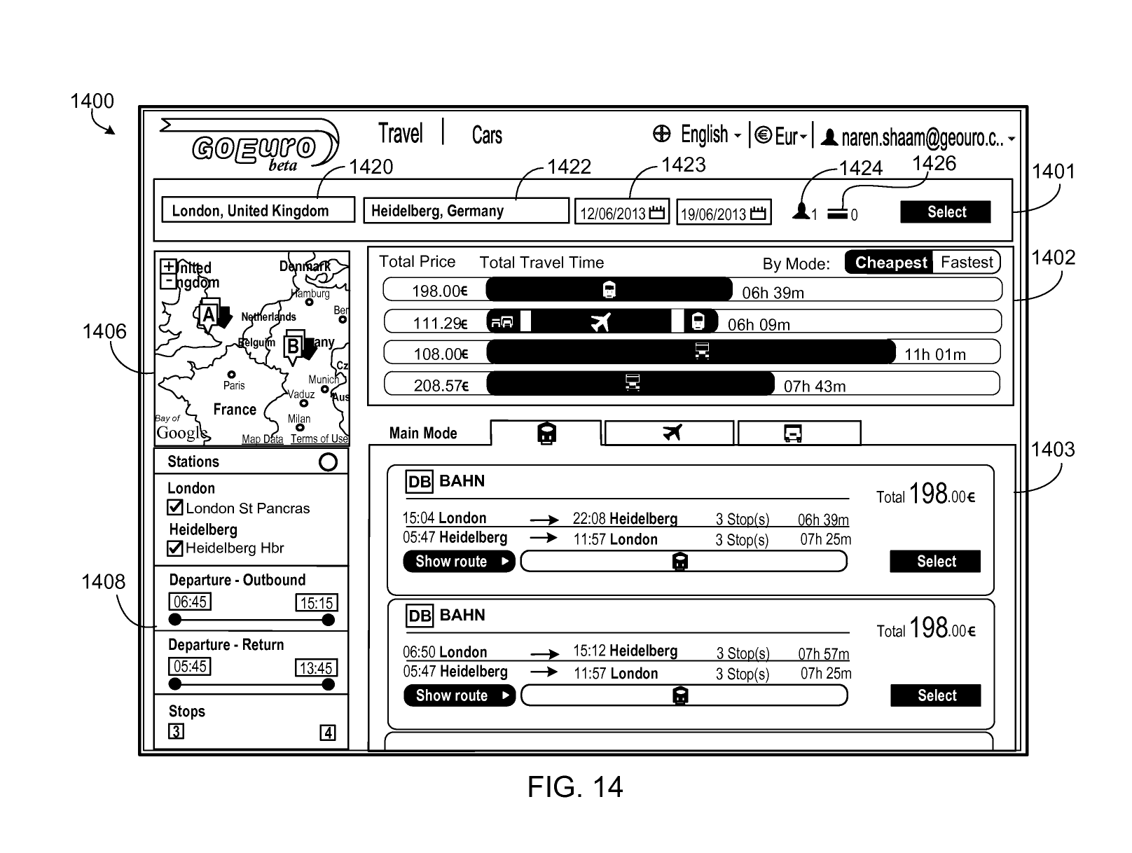

In some implementations, as shown in FIG. 14, a search results page 1400 includes a top panel bar 1401, a map 1406 a filter panel 1408 a summary table showing every mode identified by the system 1402, and search results in tabular form 1403. The top panel bar is a simple layout to show the from and to show locations 1420, 1422 selected in the home page, along with the dates of travel 1423, the number of passengers 1424, and any railway discount cards 1426 chosen. The design allows editing any of the input fields directly in the search results page.

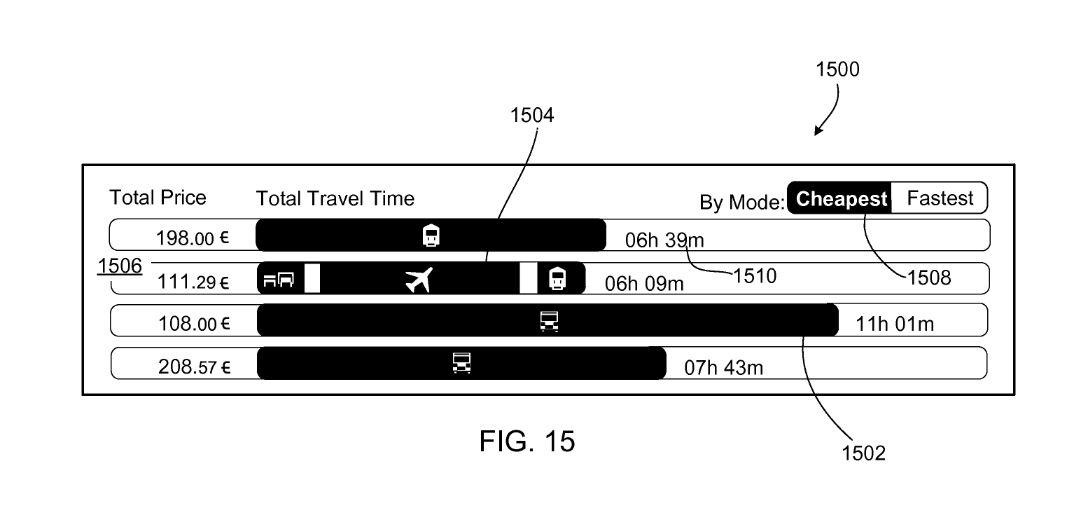

As shown in FIG. 15, the summary table 15 shows a quick preview of the (e.g., four) modes of travel that the system focuses on along with prices and total travel times 1510. The summary table provides a very graphic and simple to understand way to review all options in one screen. The horizontal bars 1502, 1504 representing modes of travel (e.g. indicated by a corresponding representative icon) move relative to each other. The bars compare the cheapest (or fastest, depending on the sorting) journey of each mode of travel (air, rail, bus, car). The comparison of the best results of each mode of travel. For example, the worst result (in terms of price or time, depending on the sorting) has a bar length of 100%. The lengths of the other bars are relative to that bar, e.g., if a bus takes 10 h and a train takes 5 h, the bus bar would be half the length of the train bar. This enables the user to easily get a true idea of travel time differences. The prices 1508 for the travel alternatives are on the left hand panel. Two buttons—cheapest and fastest 1502, on top right of the summary table allow easy preview to the user on the cost and travel time differences between the cheapest and the fastest options between two locations. The summary bars adjust relative to each other when cheapest versus fastest buttons are clicked again giving the user a simple display of time versus price comparison between the modes. The summary table also adjusts when items on the filter panel on the left are modified.

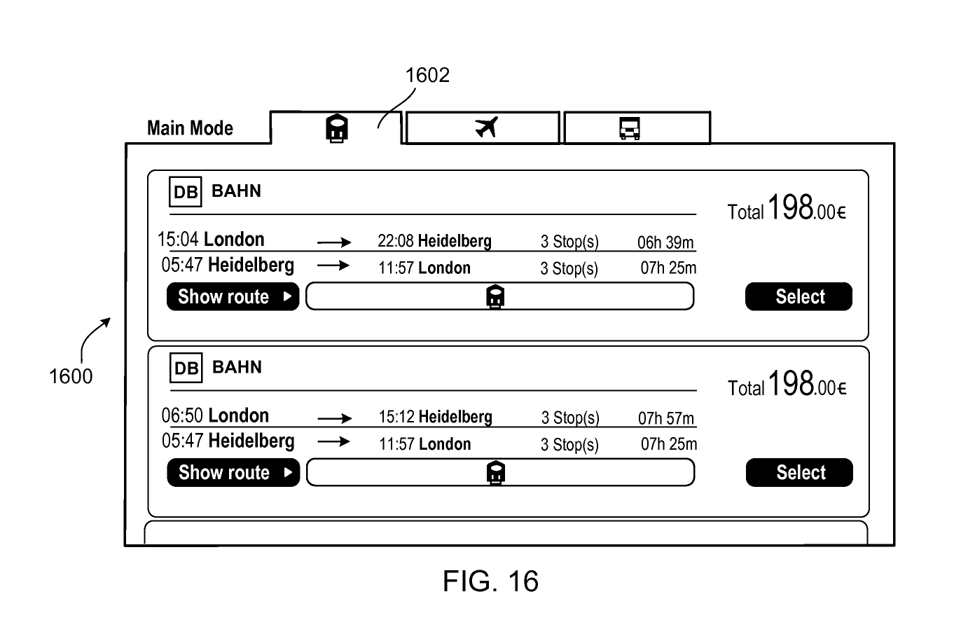

Clicking on any of the bars shown in the rows of FIG. 15 will open up the full details associated with that bar in tabular form as discussed below. For example, clicking on a train or bus summary bar in FIG. 15 opens the corresponding train or bus detailed results and all options can be seen in other tabs as described below with respect to FIG. 16.

As shown in FIG. 16, the tabbed view 1600 provides tabs each bearing a simple icon 1602 representing train, air, car, bus and public transportation, which allows a user to get a quick visual representation of all options.

The tabular results panel 1600 allows easy comparison of results with each mode. Each of the modes may be combined with the other modes such as a train+bus, but the results are shown by displaying the icon for the dominant mode on the tab. For example a journey from Heidelberg to Paris may have a train from Heidelberg to Frankfurt and a bus that departs from Frankfurt. Because this has the main leg as the bus leg, the details will be shown in the BUS tab.

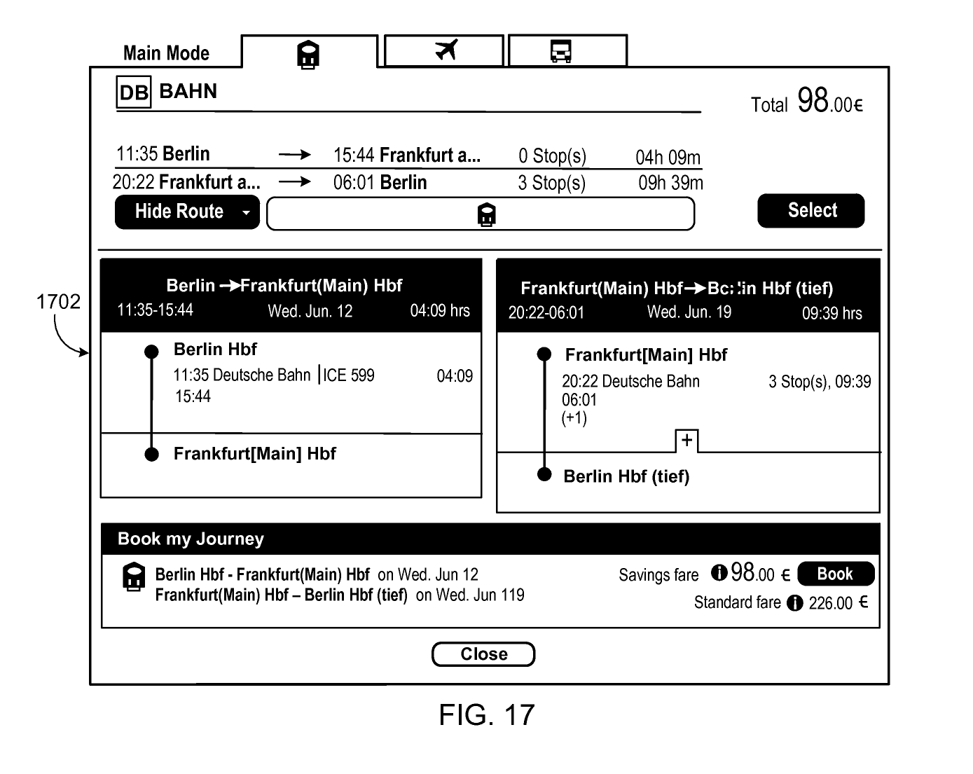

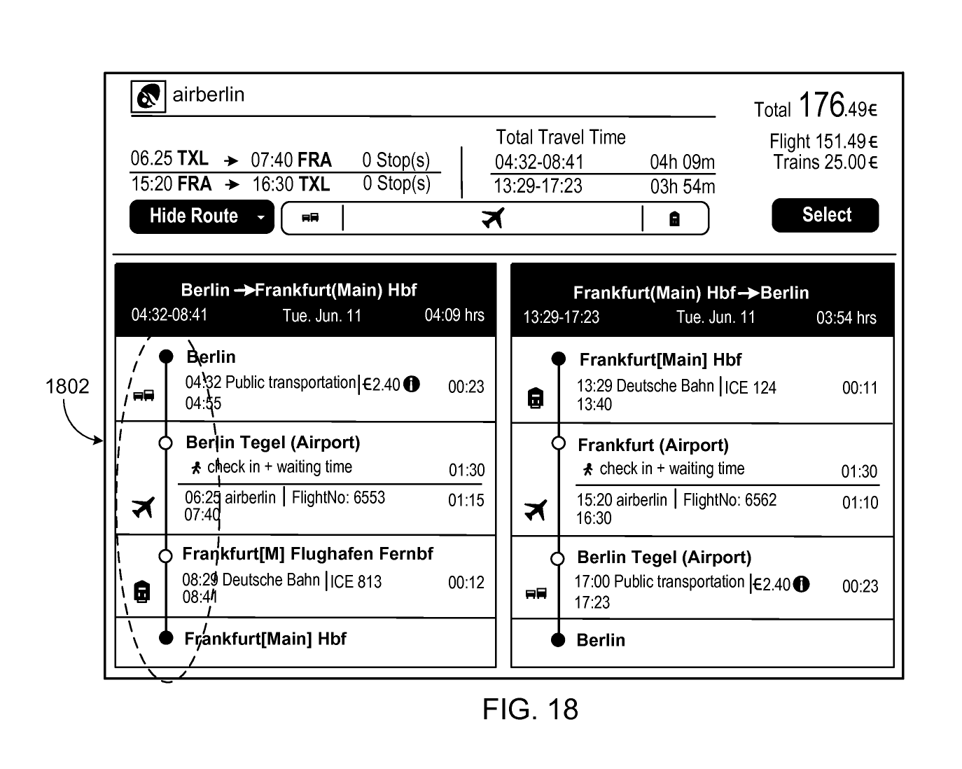

As shown in FIGS. 17 and 18, the details provided on the tab corresponding to each result may vary. For example, in FIG. 17, on the train tab 1700, only the train only journey 1702 is shown.

By contrast, in FIG. 18, on the air tab 1800, a journey from Berlin to Frankfurt in includes public transportation from Berlin to Berlin Tegel Airport (TXL), check in, and waiting time, flight from Berlin TXL to Frankfurt airport, and a train from Frankfurt airport to the city centre 1802.

In some implementations, the air tab never shows only the flight time, but rather always also includes check in and waiting time and transit to airports. In some cases, transit to airports has two options: 1. public transportation shown when the airport is in a location served by public transportation (detailed public transportation information may be shown). 2. train or bus to airport: when the user departs or arrives at a small location that doesn't have an airport, long distance train or bus is calculated using the system algorithm to show the user the complete journey. Thus, the system combines and displays different modes of travel to show the complete route, travel time, and price and not merely the air prices as in other travel websites.

In typical travel sites, prices may be given for only part of a connection, for example, when part of the route is done by public transportation.

As shown in FIG. 19, a useful behavior for a search engine like the system we are describing is to price as much of the leg 1900 as possible in order to provide the most value to the user (by providing the most information, giving a price that covers the greatest part of the trip possible, and offering the ability to book the priced part of the trip). Therefore the system we are describing first determines a most sensible station 1902 (e.g., closest) in the area of the destination 1904 and then finds priceable transportation (e.g., trains) to this most sensible station. The rest of the route (the non-priceable portions of the route 1907) which includes non-priceable stations 1907 is then filled by a routing service (without prices). The most sensible station can be (but not necessarily) determined by a routing service as well.

The techniques that we have described can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques can be performed by one or more programmable processors executing a computer program to perform functions of the invention by operating on input data and generating output. Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks or other forms of latest memory storage technology. The processor and the memory can be supplemented by, or incorporated in special purpose logic circuitry.

To provide for interaction with a user, the techniques can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer (e.g., interact with a user interface element, for example, by clicking a button on such a pointing device). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. The user can be a person, a computer, or a process, or any other user or supplier of travel data. The interface can be any possible method for information to be passed between a user and the system, including, for example, a user interface, an API, a data feed, a mobile device such as an iPad or a tablet, a mobile app, and machine to machine communication.

The techniques can be implemented in a distributed computing system that includes a back-end component, e.g., as a data server, and/or a middleware component, e.g., an application server, and/or a front-end component, e.g., a client computer having a graphical user interface and/or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet, and include both wired and wireless networks.

The computing system can include clients and servers. A client and server are generally remote from each other and typically interact over a communication network. The relationship of client and server arises by virtue of computer programs running on the respective computers and having a client-server relationship to each other.

Other embodiments are within the scope of the following claims.

1. A method comprising
by computer calculating the cost of a travel itinerary of a user from an origination location to a destination location,
taking account in the calculation of a discount or promotion that is available to the user to be applied against the cost of at least one part of the travel itinerary, and
providing the calculated cost of the itinerary to the user through an online user interface.

2. The method of claim 1 in which the travel itinerary includes two or more parts.

3. The method of claim 1 in which taking account of the discount or promotion comprises using information about the discount or promotion that is maintained as part of a stored profile of the user.

4. The method of claim 1 in which taking account of the discount or promotion comprises using information about the discount or promotion that is provided by the user through the user interface.

5. The method of claim 1 in which calculating the cost of the travel itinerary includes calculating the costs of alternative possible itineraries and taking account of the discounts or promotions available for the respective alternative itineraries.

6. The method of claim 1 in which the discount or promotion comprises a bonus card.

7. The method of claim 1 in which the user is asked to enter information about the discount or promotion by presenting a selection list of available discounts and promotions to the user, and the presented selection list does not include discounts or promotions that are not relevant to the itinerary for which the cost is being calculated.

8. The method of claim 1 comprising
displaying to a user in the online user interface a graphical representation of alternative possible travel itineraries for travel from the origination location to the destination location, at least two of the alternative possible travel itineraries including different modes of travel, the graphical representation being arranged to show the cost and the duration of each of the possible travel itineraries.

9. The method of claim 8 in which at least one of the possible travel itineraries includes two different modes of travel.

10. The method of claim 8 in which the graphical representation is adjusted when a user invokes a control to choose the cheapest itinerary or the shortest itinerary.

11. The method of claim 8 in which a graphical representation associated with each of the itineraries can be invoked by a user to cause full details of the itinerary to be displayed.

12. The method of claim 8 in which the graphical representation comprises bars.

13. The method of claim 11 in which the full details of the different itineraries are presented in respective tabs of a tabbed panel.

14. The method of claim 13 in which each of the tabs is associated with a corresponding mode of travel.

15. The method of claim 14 in which the mode of travel associated with a tab is the mode of travel of a main leg of the corresponding itinerary.

16. The method of claim 13 in which the full details for an air tab include not only the air time but waiting time and time for transit to or from an airport.

17. The method of claim 16 in which transit time includes, optionally time for public transportation when the airport is served by public transportation and optionally time for train or bus to the airport if one is available.

18. A method comprising
by computer calculating a cost of a travel itinerary of a user from an origination location to a destination location, the travel itinerary having a portion that is priceable and a portion that is not priceable, the cost being calculated by pricing as much of the itinerary as possible.

19. The method of claim 18 in which the calculating comprises determining a station that is nearest to the destination location and finding priceable travel mode to the determined station.
